(19) United States
(12) Patent Application Publication
(10) Pub. No.: US 2011/0270687 A1
(43) Pub. Date: Nov. 3, 2011

(54) APPARATUS AND METHOD FOR CONTROLLED DELIVERY OF DIRECT MARKETING MESSAGES

(76) Inventor: Gaurav BAZAZ, Manlius, NY (US)

(21) Appl. No.: 13/096,530

(22) Filed: Apr. 28, 2011

Related U.S. Application Data
(60) Provisional application No. 61/330,046, filed on Apr. 30, 2010.

(51) Int. Cl. G06Q 30/00

(52) U.S. Cl. 705/14.66

(57) ABSTRACT

A system is provided for controlling delivery of direct marketing messages from marketers to subscribers. An aggregator (third-party intermediary) collects permissions from subscribers and acts as the enforcer of their preferences while allowing the marketers to connect with the subscribers on-demand. The benefits to the marketers include: on-demand access to consumers and corporate decision makers (subscribers); recipient (subscriber) defined preferences based upon delivery (e.g., time, frequency, channel) and profile (e.g., interests, hobbies, planned purchases); and automatic compliance with subscriber preferences.

### RELATED APPLICATION

This application claims the benefit of priority to U.S. Provisional Application 61/330,046 filed 30 Apr. 2010, the entire disclosure of which is incorporated by reference.

### FIELD OF THE INVENTION

The present invention relates to the delivery of email and phone marketing messages.

### BACKGROUND

Email marketing and phone marketing (telemarketing) campaigns have become increasingly difficult and expensive due to new regulations intended to protect consumers from unsolicited marketing messages. As a result, the principal difficulty in running such campaigns is now overcoming the “permission” problem. A marketer cannot send emails (spam) or make phone calls (do-not-call lists) without the recipient's consent. The introduction of the do-not-call laws in 2003-2004 and the Can-spam Act impose potentially severe penalties on marketers that violate these provisions. Above all, unlike before they cannot send promotions to people without obtaining their prior permission.

### SUMMARY OF INVENTION

In accordance with various embodiments of the present invention, apparatus and methods are provided for solving this problem by creating a subscriber base of consumers and companies who can be reached on an on-demand basis by marketers without having to acquire permissions one-by-one. Avoiding the one-by-one permission process, which is naturally a very slow and expensive process for business, is one feature of the present invention. In addition, the invention provides consumers and business decision maker's control over the messages being sent to them.

According to one embodiment of the invention, a system is provided for controlling delivery of direct marketing messages from marketers to subscribers. An aggregator (third-party intermediary) collects permissions from subscribers and acts as the enforcer of their preferences while allowing the marketers to connect with the subscriber's on-demand. The benefits to the marketers include:
on-demand access to consumers and corporate decision makers (subscribers);
recipient (subscriber) defined preferences based upon delivery (e.g., time, frequency, channel) and profile (e.g., interests, hobbies, planned purchases); and
automatic compliance with subscriber preferences.

For subscribers, the benefits include control over the delivery of direct marketing messages from marketers, by one or more of email, phone and other channels of communication.

According to one embodiment of the invention, a system is provided which includes the following components:
1) a subscriber database with permissions and subscriber profile data;
2) an on-line control center (e.g., Web site) provided by an aggregator from which subscribers can control the delivery of messages sent to them;
3) an on-line platform provided by the aggregator that includes an interface for marketers to send messages to targeted subscribers without ever revealing (to the marketers) any of the subscriber's personal identifiable information (including their contact information);
4) a scheduling system that ensures messages are only sent to subscribers based on their preferences, while allowing marketers to easily set up campaigns without having to worry about when and how the messages will be delivered.

According to one embodiment, the invention can be implemented in hardware and/or software and may include a database, a scheduling system, a message delivery system, and an interface which ensures anonymization (prevents disclosure of consumer personal identifiable information).

As used herein, a direct marketing message (DMM) is one that requires recipient contact information, e.g., an email address, telephone number, twitter handle, etc.

In accordance with one embodiment, a computer-readable medium is provided storing instructions for performing a method comprising:
offering each of a plurality of subscribers preferences for controlled delivery of direct marketing messages (DMMs) from marketers to each subscriber;
receiving from each subscriber an individual set of the preferences and storing the preferences;
receiving DMMs from the marketers and storing the DMMs;
scheduling delivery of the DMMs to the one or more subscribers based on each subscriber's individual set of preferences.

The method may include offering preferences to each subscriber based on one or more of:
delivery time;
delivery channel;
delivery frequency;
one or more interests of the subscriber;
one or more hobbies of the subscriber;
one or more planned purchases of the subscriber;
blocking one or more sources or senders of marketing messages.

The method may include:
receiving personal identifier information for each subscriber and storing the information;
shielding the personal identifier information from the marketers.

The method may include:
maintaining a database of the preferences and personal identifier information.

The method may include:
providing the offering and receiving steps as a Web-based process.

The method may include delivering the scheduled DMMs to the one or more subscribers. The delivering step may include one or more of email, phone and other channels of communication.

The method may include:
the marketers defining potential subscribers and the offering is made only to such potential subscribers.

In accordance with another embodiment, a computer-implemented method is provided comprising:
offering a plurality of direct marketing messages (DMMs) from marketers to subscribers;
receiving data from each subscriber identifying preferences for controlled delivery of the DMMs;
receiving data from each marketer identifying targets for the DMMs;
matching the preferences of the subscribers and the targets of the DMMs; and
scheduling delivery of the DMMs to one or more of the subscribers based on the matched preferences.

The preferences may include delivery preferences and profile preferences.

In accordance with another embodiment, a network-based delivery system is provided comprising:
a database containing preferences for each of a plurality of subscribers, the preferences including profile parameters and delivery parameters;
a controller managing a schedule for controlled delivery of direct marketing messages (DMMs) to the subscribers based on the preferences of each subscriber, wherein the controller operates via a network to:
   receive the preferences from the subscribers;
   search the database for preferences matching the DMMs; and
   deliver the DMMs to one or more of the subscribers based on the matched preferences.

The system may include a Web-based interface.

In the system, the database may include personal identifier information for each subscriber; and an interface for marketers to identify target subscribers for the DMMs without disclosing the personal identifier information to the marketers.

In another embodiment, an apparatus is provided comprising:
an aggregator database containing preference and personal identifier information for each of a plurality of subscribers, the preferences identifying profile parameters and delivery parameters for each subscriber;
a network-based scheduling controller accessing the database and delivering direct marketing messages (DMMs) from a plurality of marketers to one or more of the subscribers based on each subscriber's preferences without disclosing the personal identifier information to the marketers.

In another embodiment, a computer-implemented method is provided comprising:
receiving from each of a plurality of subscribers preferences for controlled delivery of direct marketing messages DMMs from marketers to the subscribers, and storing the preferences;
when an individual subscriber requests a search on an Internet search engine, associating a subject matter of the search with the individual subscriber and storing the associated search and subscriber data;
collecting a plurality of the associated search and subscriber data relating to a common subject matter;
offering the collection of subscribers to the marketers for submission of a DMM campaign to the collection of subscribers;
scheduling delivery of the DMMs to the collection of subscribers based on each subscriber's preferences.

The preferences may include delivery preferences and profile preferences.

The method may include:
receiving personal identifier information from the subscribers;
shielding the personal identifier information from the marketers.

The method may include:
the scheduled delivery is by one or more of email, phone and other communication channels.

The method may include:
the marketers define potential subscribers.

The method may include:
maintaining a database of the preferences and personal identifier information and delivering the DMMs to the subscribers without disclosure of the subscriber personal identifier information to the marketers.

In another embodiment, a computer-readable medium is provided storing instructions for performing a method comprising:
offering each of a plurality of subscribers preferences for controlled delivery of direct marketing messages (DMMs) from marketers to each subscriber;
receiving from each subscriber an individual set of the preferences and storing the preferences;
receiving DMMs from the marketers and storing the DMMs;
scheduling delivery of the DMMs to one or more of the subscribers based on each subscriber's individual set of preferences;
offering to the subscribers a customer service account with one or more of the marketers.

The method may include:
the account providing access to a live agent of the marketer.

The method may include:
the account providing the subscriber with a phone number to reach the live agent.

The method may include:
the account providing the subscriber with a code for obtaining access to the live agent.

### BRIEF DESCRIPTION OF THE DRAWINGS

Various embodiments of the present invention will now be described with reference to the attached drawings, in which:

FIG. 1 is a schematic block diagram illustrating one embodiment of a platform from the view of a network member company (marketer). An aggregator serves as an intermediary (central block) between a plurality of marketers (top block) and a plurality of subscribers (bottom block). The marketers provide direct marketing campaigns to be delivered by email, telephone and other communication channels to the aggregator, for subsequent delivery to select subscribers. The subscribers provide subscriber contact information, preferences and historical response data to the aggregator. The aggregator provides each of the functionalities identified in the sub-blocks (within the central block) for storing, processing and/or communicating with each of the marketers and subscribers. Finally, the aggregator processes and sends select direct marketing messages from the marketers to the subscribers based upon each individual subscriber's preferences, such delivery being through one or more of the communication channels identified in the sub-blocks of the subscriber block.

FIGS. 2A-2B are schematic diagrams comparing a current (prior art) model in which personal messages and marketing messages are both sent directly to a subscriber (FIG. 2A), with an embodiment of the present invention wherein personal messages can be sent directly but marketing messages are controlled by an intermediary for delivery to the subscriber (FIG. 2B).

FIG. 3 is a chart outlining how the described embodiment solves multiple problems, the problems being outlined on the left-hand side of FIG. 3, and the solutions according to one embodiment of the invention outlined on the right-hand side of FIG. 3.

FIG. 4 is a flow chart illustrating a work flow of network operations according to one embodiment of the present invention.

FIG. 5 is a schematic block diagram illustrating a data flow between the subscriber(s), aggregator and marketer(s) according to one embodiment of the invention.

FIGS. 6A-6E are a series of schematic flow diagrams of a scheduling system according to one embodiment of the present invention for controlling delivery of direct marketing messages.

FIG. 7 is a flow chart of a phone marketing delivery method according to one embodiment of the invention.

FIGS. 8A-8B are interfaces from an aggregator Web site illustrating one embodiment of a network interface allowing a marketer to select target subscribers for its direct marketing messages such that the personal identifier information of such subscribers is not disclosed to the marketer. For example, in FIG. 8A the marketer can create a list of one or more parameters to identify target subscribers that the marketer would like to receive a given marketing message. Such parameters may include the subscriber's age, gender, state, income range, etc.

In FIG. 8B four charts (bar graphs) are shown in which a pool of subscribers are collectively referred to (grouped) in terms of education, income, state and age. For a specified target list, these charts show the statistical profile of the subscribers which satisfy the defined target parameters.

FIGS. 9A-9D are interfaces from the aggregator's Web-based control center for use by subscribers according to one embodiment of the invention. The illustrated Web pages provide input boxes of various types for the subscriber to enter, review and/or edit his or her delivery and profile preferences and personal identifier information.

FIG. 10 is a schematic block diagram illustrating one embodiment of a search and direct marketing system and method.

FIG. 11 is a flowchart illustrating one embodiment of a system and method for creating subscriber accounts and responding to subscriber requests for customer service.

### DETAILED DESCRIPTION

### A. Controlled Delivery

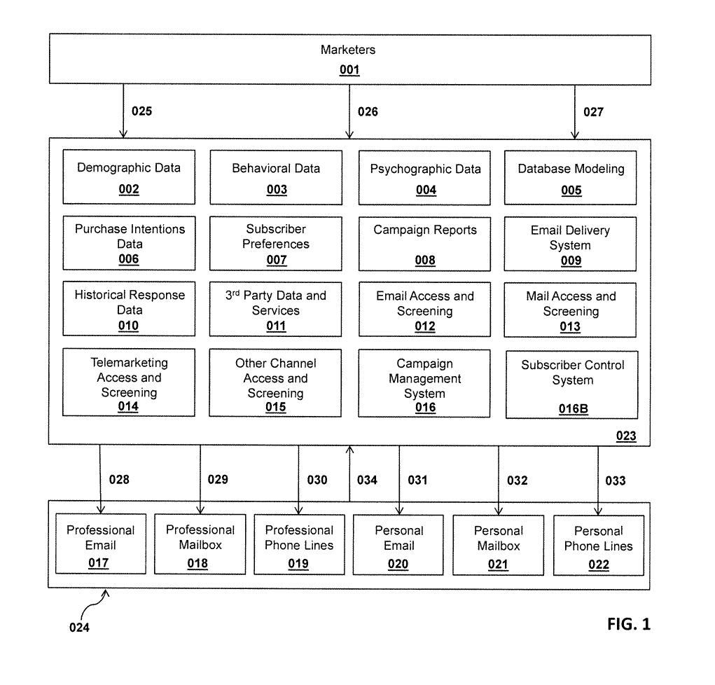

FIG. 1 is a schematic illustration of one embodiment of the invention showing the different components of the invention and their inter-relationship. 001 is one or more marketers who use a platform 023 to run direct marketing campaigns on-demand. 023 is the platform which as described herein consists of various components which facilitate in the delivery of direct marketing campaigns for both the marketer(s) 023 and the subscriber(s) 024. 024 represents the subscriber to the platform, who receives the marketing messages from the marketer 001. The presence of all the component elements of 023 is not required in every embodiment, and other elements can be added.

The platform 023 consists of the following components in this one embodiment: demographic data 002 which consists of the demographic information about the subscriber such as location, age, income level, ethnicity etc.; behavioral data 003 which consists of data regarding the interactions of the subscriber with the platform, such as clicks, email opens, purchases made through marketing messages delivered among other information; psychographic data 004 which consists of the interests and hobbies of the subscriber; database modeling features 005 which allow the marketer to forecast the responsiveness of different subscribers to his marketing campaign; purchase intentions data 006 which consists of data about the items the subscriber is planning to purchase; subscriber preferences data 007 which consists of information about the manner and times at which the subscriber prefers to be contacted—days, times, channels etc.; campaign reports 008 which feature allows the marketer to get information about the performance of his campaigns in terms of click throughs, purchases made and other data; email delivery system 009 which manages the non-trivial process of getting the marketing emails delivered to the email inbox of the subscriber; historical response data 010 which consist of data regarding the purchases made by the subscriber across marketers using the platform, which can be of great predictive value in forecasting future responsiveness to marketing messages; data and services acquired from third parties 011 which can add to the forecasting capability and quality of marketing messages delivered in marketer campaign; email access and screening system 012 which queues marketing emails, schedules their delivery, screens out marketing messages based on subscriber preferences and manages the delivery of the emails; mail access and screening system 013 which performs the same function as 012 for direct mail (postal) marketing messages; telemarketing access and screening system 014 which performs the same function as 012 for phone marketing calls; other channel access and screening system 015 which performs the same function as 012 for other channels such as social networks and SMS messages; campaign management system 016 which consists of the various software components required to help the marketer setup, manage, optimize and monitor marketing campaigns; subscriber control system 016B which allows the subscriber to set preferences and control the flow of messages from the marketers; professional email of the subscriber 017 which refers to the email account of the subscriber at his or her job; professional mailbox 018 which consists of the postal mailbox of the subscriber at his or her job; professional phone line 019 which refers to the phone line of the subscriber at his or her job; personal email 020 which refers to the personal email account of the subscriber; personal mailbox 021 which refers to the personal postal mailbox of the user; personal phone line 022 which refers to the subscriber's personal phone line.

The subscriber 024 contributes to the platform 023 various data through the process 034. This includes demographic, behavioral and psychographic data as well as preferences and purchase intentions data. The data is contributed on an on-going basis over time as well as initially when the subscribers joins the platform. The marketer sets up an email marketing campaign 025 or a telemarketing campaign 026 or a marketing campaign through another direct channel 027 on the platform 023. The platform delivers the campaign messages to the subscriber 024 according the requirements of the campaign and the preferences of the subscriber 024 to the subscriber's various reception points (portals) including professional email account 017 through process 028, professional mailbox 018 through process 029, professional phone line 019 through process 030, personal email account 020 through process 031, personal mailbox 021 through process 032 and personal phone line 022 through process 033. Other reception points such as mobile SMS account and social network accounts can also be added and are within the scope of the present invention.

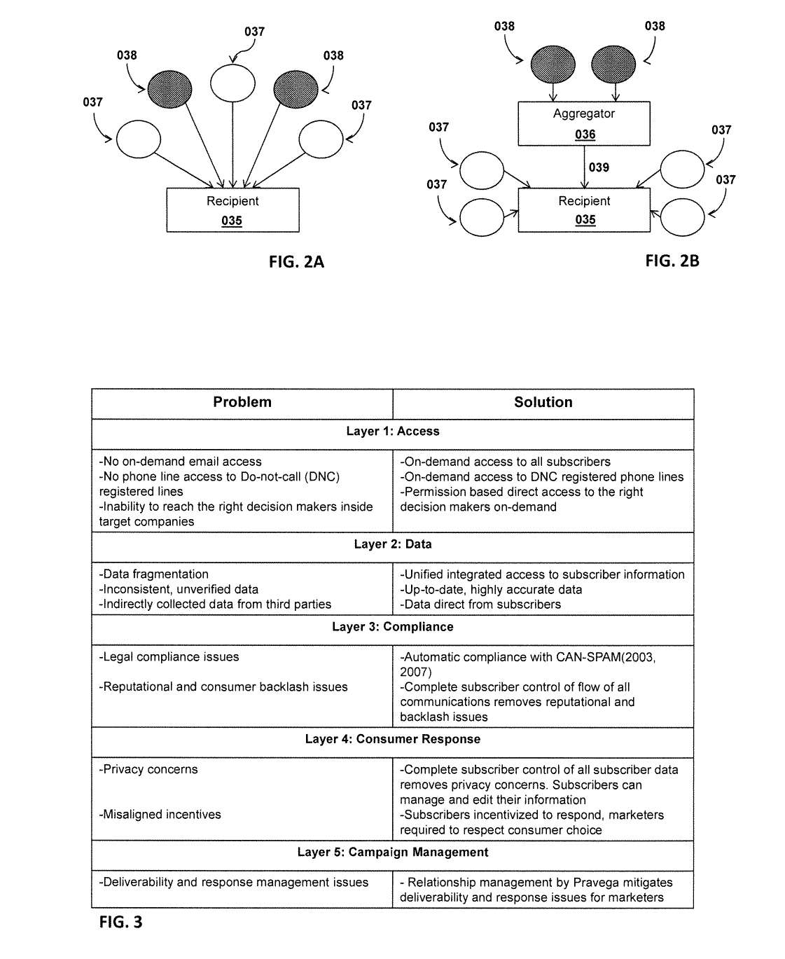

FIG. 2A and FIG. 2B describe one aspect of the invention from the perspective of the subscriber, here shown as the recipient 035. In FIG. 2A, which represents the current (prior art) model, the recipient 035 receives both marketing messages 038 and non-marketing messages 037 directly. Non-marketing messages refer to messages such as messages from family, friends and colleagues. FIG. 2B shows the change in this model with the present invention. The recipient 035 no longer receives all messages directly. While non-marketing messages 037 continue to reach the subscriber directly, marketing messages 038 are now channeled through the aggregator platform 036 which screens the messages and allows the subscriber to control their flow 039 to the subscriber. The aggregator platform 036 is, in one embodiment, the same as the platform 023 in FIG. 1.

FIG. 3 is a chart outlining how the described embodiment solves multiple problems, the problems being outlined on the left-hand side of FIG. 3, and the solutions according to one embodiment of the invention outlined on the right-hand side of FIG. 3.

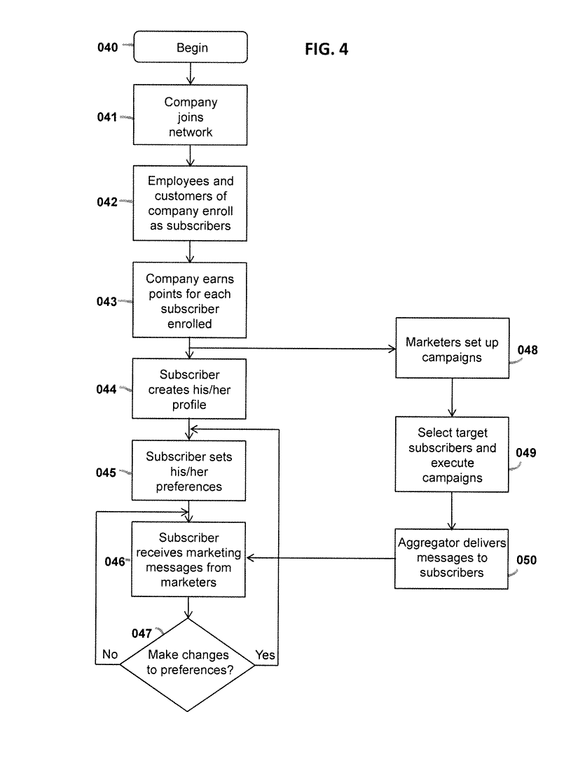

FIG. 4 is a flowchart describing the workflow of a company using the platform, under a particular embodiment of the present invention, wherein the company joins a network of companies, and enrolls its employees and customers as subscribers to the platform (023, 036) and uses the same platform to run marketing campaigns. The process starts at 040. The company joins the network in 041 to become a network member. The company then enrolls its employees and customers as subscribers to the platform in 042. The company earns points for each individual it enrolls as a subscriber to the platform in 043. The enrolled subscriber then creates his or her profile on the platform at 044 after which he or she sets his/her preferences at 045. The marketers from the company set up marketing campaigns at 048 by selecting the target subscribers and executing the campaign at 049. The subscribers selected by the marketers for their campaign can be any subscribers from the database of the platform, including customers and employees of other network member companies as well the ones they enrolled themselves. The aggregator platform delivers the messages of the campaign at 050 which are received by the subscriber at 046. The subscriber can then choose to make changes to his/her preferences or keep them unchanged at 047.

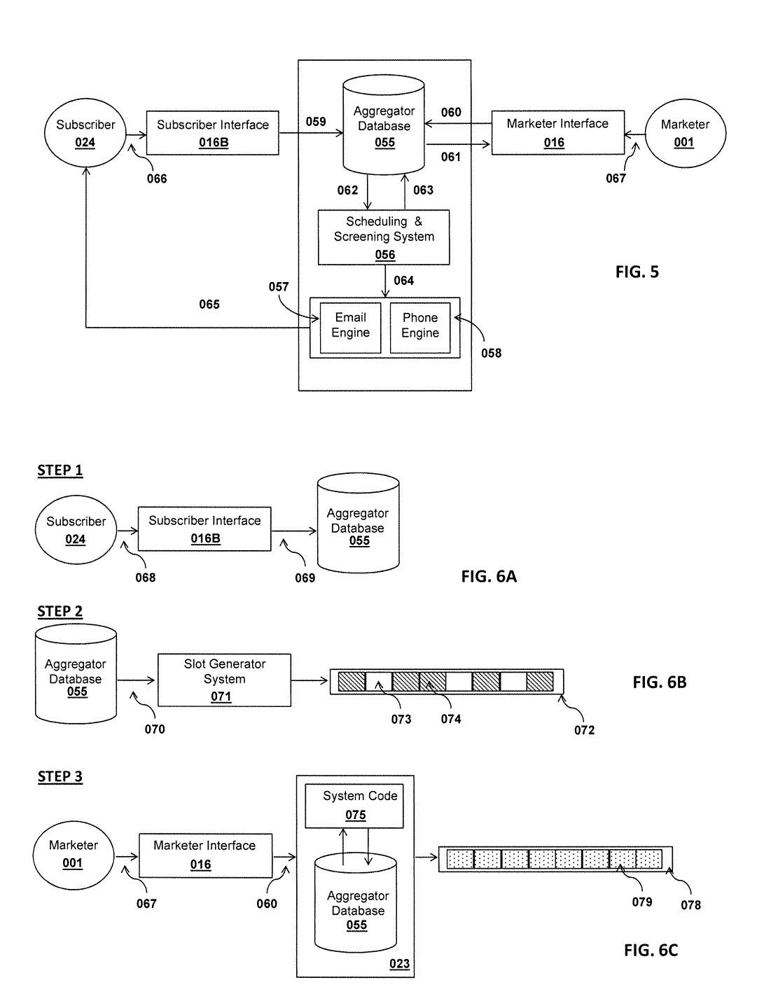

FIG. 5 is a schematic block diagram illustrating the data flow between the subscriber(s), aggregator and marketer(s) according to one embodiment of the invention. The subscriber 024 interacts with a subscriber interface, here the web based subscriber control center 016B, to set his or her preferences and profile through process 066. This data is then stored in the aggregator platform database 055 by the subscriber interface 016B through the process 059. The marketer 001 interacts with the marketer interface 016 to set up his or her campaign through the process 067. The marketer acquires information necessary to set up the campaign such as information regarding the subscribers and the message delivery schedule from the aggregator database 055 through the process 061 which is in turn displayed to the marketer by the interface 016. The details of the campaigns, such as list(s) of subscribers to target, the content of the message(s) and timing of campaign delivery are then stored in the aggregator database by the interface 016 through the process 060. The scheduling and screening system 056 interacts with the database 055 to acquire the necessary data for scheduling the campaign through the process 062. This includes data such as subscriber preferences, nature of marketing campaign, timing of campaign set by marketer, and information about other scheduled campaigns, among other data. The scheduling and screening system 056 then forms the schedule for the delivery of the messages which is returned to the database through process 063 and also sent to the delivery engines for various channels, including the email engine 057 and phone engine 058, through process 064. The delivery engines 057 and 058 then deliver messages to the subscriber 024 through the process 065, based on the schedule set up by the scheduling system 056.

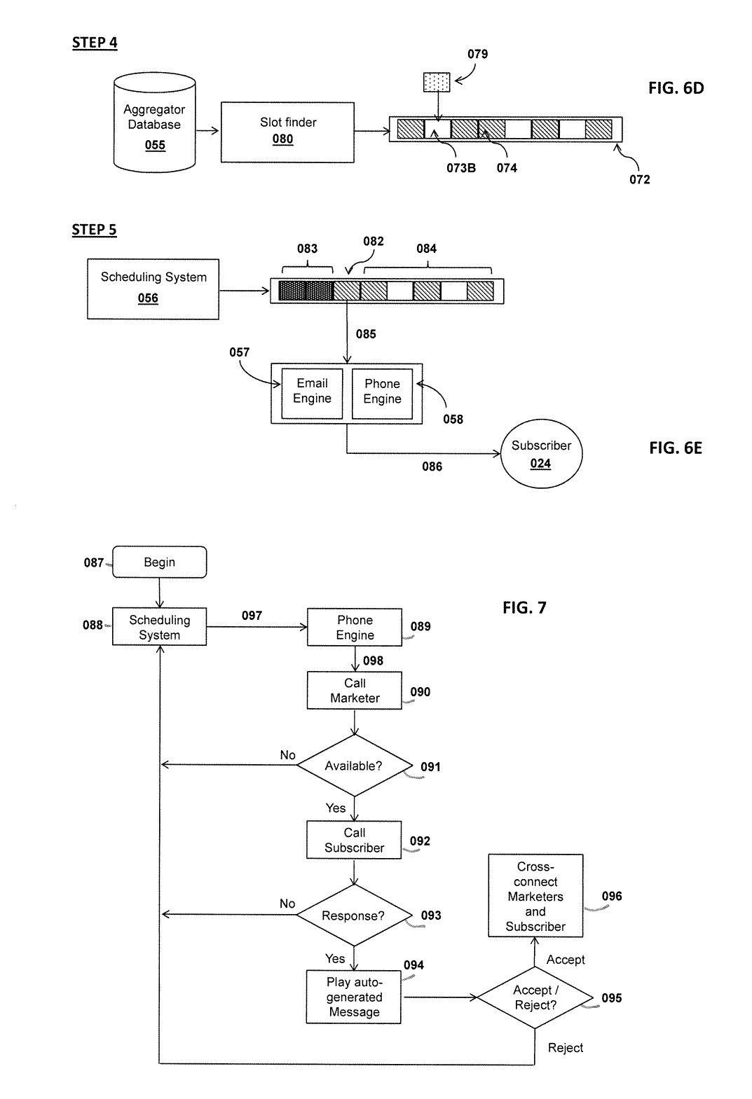

FIGS. 6A-6E describe the functioning of the scheduling system according to one embodiment. FIG. 6A describes a first step, which involves the subscriber 024 setting his or her profile and preferences through the process 068. Preferences include information about when, at what time and through which channel (email, phone etc) the subscriber prefers to be contacted. The subscriber also sets his/her interests which helps the aggregator platform screen out irrelevant messages. The subscriber sets his/her preferences through the interface 016B which in turn stores the data in the aggregator database 055 through the process 069. FIG. 6B describes the next step, which involves the slot generator system 071 taking the preferences data from the aggregator database 055 through the process 070 and generating the delivery slots in the delivery slots table 072. The slots represent a point in time when a message can be sent to the user based on the user preferences. The delivery slots table 072 includes slots that have already been filled with previously scheduled campaigns 074, as well as free slots which can be filled with future campaigns 073. FIG. 6C describes the set up of the campaigns by the marketer 001 resulting in the formation of a message delivery queue 078. The marketer 001 interacts with the marketer interface 016 to set up the campaign through the process 067. The data related to the campaign is then sent to the platform 023 through process 060. A system code 075 within the platform 023 interacts with the database 055 to generate a delivery queue 078 which consists of a series of messages 079 that need to be delivered to the subscribers for the campaign. FIG. 6D describes the process of inserting the delivery messages 079 into the delivery slots table 072 in slots that currently are free 073. The slot finder 080 gets data from the database 055 to find the earliest available free slot 073B in the delivery slots table 072 that is past the campaign start date. Once an acceptable slot is found, the slot finder 080 inserts the message 079 into the free slot 073B. FIG. 6E describes the final step where the scheduling system 056 finds the current delivery message 082, sends it to the appropriate delivery engine through the process 085, email engine 057 for email or phone engine 058 for phone calls or another engine for other channels not shown here, which in turn deliver the message to the subscriber 024 through the process 086. Delivery messages in the past 083 and those in the future 084 are ignored by the scheduling system.

FIG. 7 is a flow chart of a phone marketing delivery method according to one embodiment of the invention. The model described in the flow chart can achieve multiple objectives: (a) schedule calls to subscribers at the time the subscribers have indicated their preference to receive calls, (b) prevent calls from marketers that a subscriber does not wish to hear from, (c) provide meaningful and relevant information to the subscriber about the upcoming call before engaging the calling agent, (d) allowing the subscriber to choose to talk or not talk with the calling agent, (e) ensuring there are no dropped calls and (f) allowing the marketer to achieve higher calling efficiency by reducing the number of calls to uninterested subscribers. The process starts at 087. At 088 the scheduling system engages the phone engine through process 097 to make a call to the calling agent as required by the calling schedule previously developed based on campaign requirements and subscriber preferences. At 089 the phone engine sets up the system to initiate a call to the calling agent (the marketer) to ensure the calling agent is online before calling the subscriber. At 090 the call is made to the calling agent. At 091 the system checks if the calling agent is available; if the agent does not respond to the call, the system assumes the agent is not available and returns to the scheduling system for the next call. If the agent is available and responds to the call, the system calls the subscriber at 092. At 093 the system checks if the subscriber is available or not. If the subscriber does not respond, the system assumes the subscriber is not available and returns to the scheduling system, which re-schedules the call. If the subscriber responds, the system moves to 094 where an auto-generated message is played to the subscriber. The message gives the subscriber details about the upcoming call, such as the caller name, company the calling agent represents, the product they are selling, the estimated length of the call, etc. Next, at 095, the subscriber can decide to disengage by dropping the call, in which case the call is cancelled and the system returns to the scheduling system at 088. But if the subscriber continues with the call, the system assumes the subscriber has accepted the call, and proceeds to connect the subscriber with the calling agent at 096 at which point the agent can start making his sale to the subscriber.

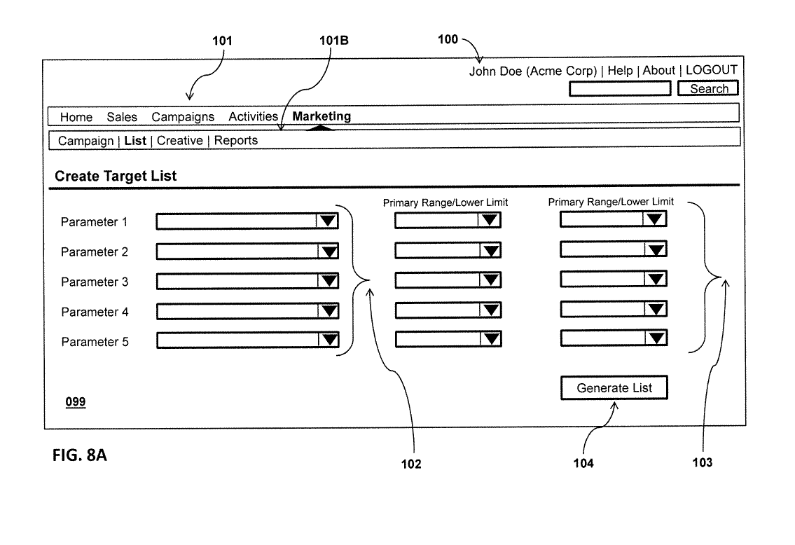

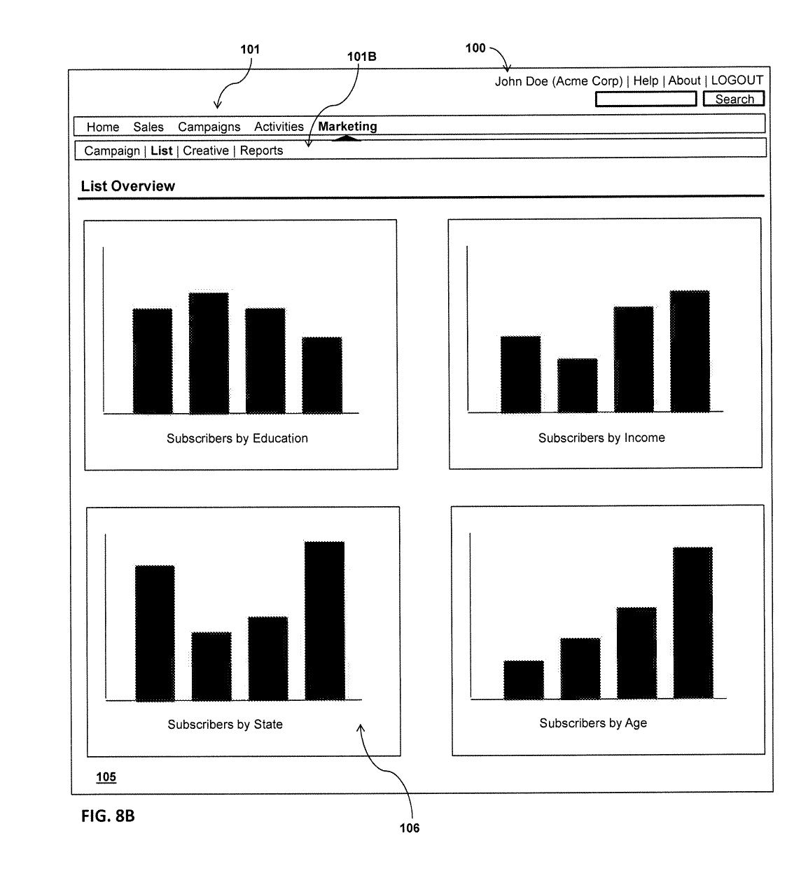

FIGS. 8A-8B are schematic illustrations of one embodiment of a system interface allowing a marketer to select target subscribers for its direct marketing messages such that the personal identifier information of such subscribers is not disclosed to the marketer. For example, in FIG. 8A the marketer can create a list of one or more parameters to identify target subscribers that the marketer would like to receive a given marketing message. Such parameters may include the subscriber's age, gender, state (location), income range, etc. The entire screen 099 consists of multiple elements. At the top right the interface provides some general management features in the account management panel 100, such as Username, Help function and Logout link. Next the interface provides a general navigation panel 101 which allows the user (marketer) to navigate to various modules in the software application such as Home screen, Sales module, Campaigns module, Activities module and more. Below the general navigation panel, the interface provides a contextual navigation panel 101B, which varies depending on which module the user is currently using. Below the contextual navigation panel, in the main screen area are multiple components which allow the user to select the parameters that define the list of subscribers the marketer will reach through the marketing campaign. In the first column 102 are a series of dropdown boxes which allow the user to select the parameters across which he or she wants to select the list. The parameters may include items such as age, education, income level, location, profession, etc. In the next two columns 103, the user defines the range for the selected parameters across which to filter the subscriber database. For instance, the user can select age as the parameter in 102 for Parameter 1, and then select 25 as the lower limit in 103 in the left hand column, and select 35 as the upper limit in the right hand column of 103. This would filter the database to select only those subscribers who are between the ages 25 and 35. Finally, the interface provides a button 104 which when pressed by the user causes the system to query the database and generate the search results of the selection made by the user.

FIG. 8B shows the database search results generated by the interface as a result of the above operation. Once the user clicks the button 104, screen 105 is generated. This screen provides a broad statistical overview of the subscribers in the list generated from the operation in the screen of FIG. 8A through a series of charts (e.g., bar graphs) as shown in 105, including charts such as 106 which display the distribution (number) of the selected subscribers in various states.

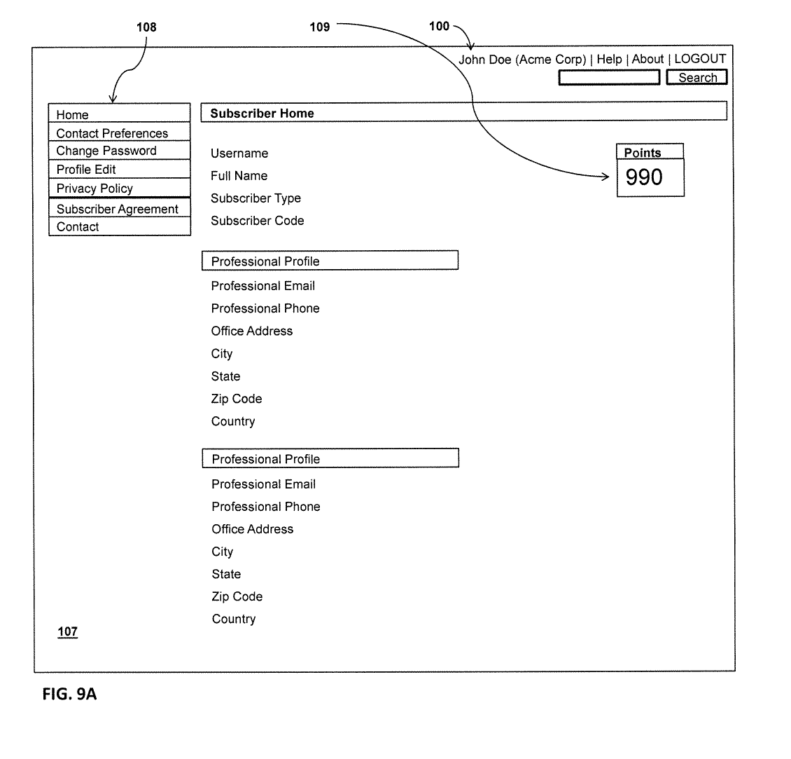

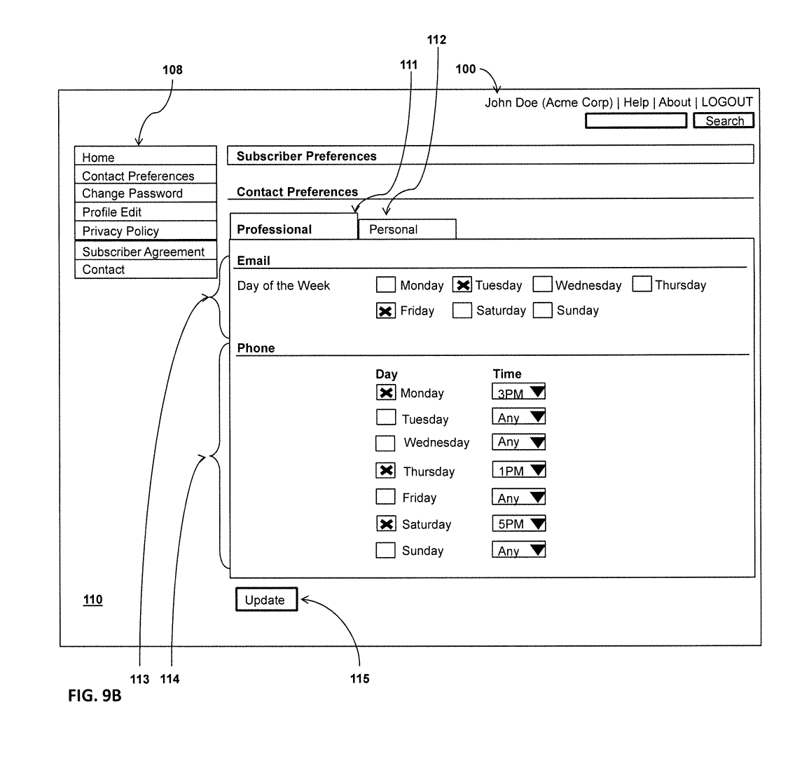

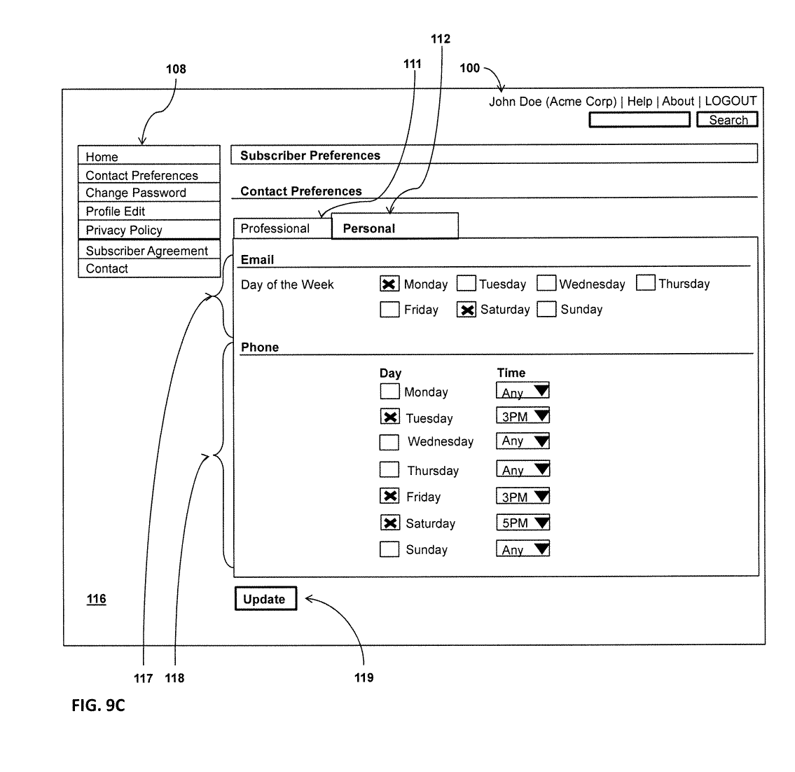

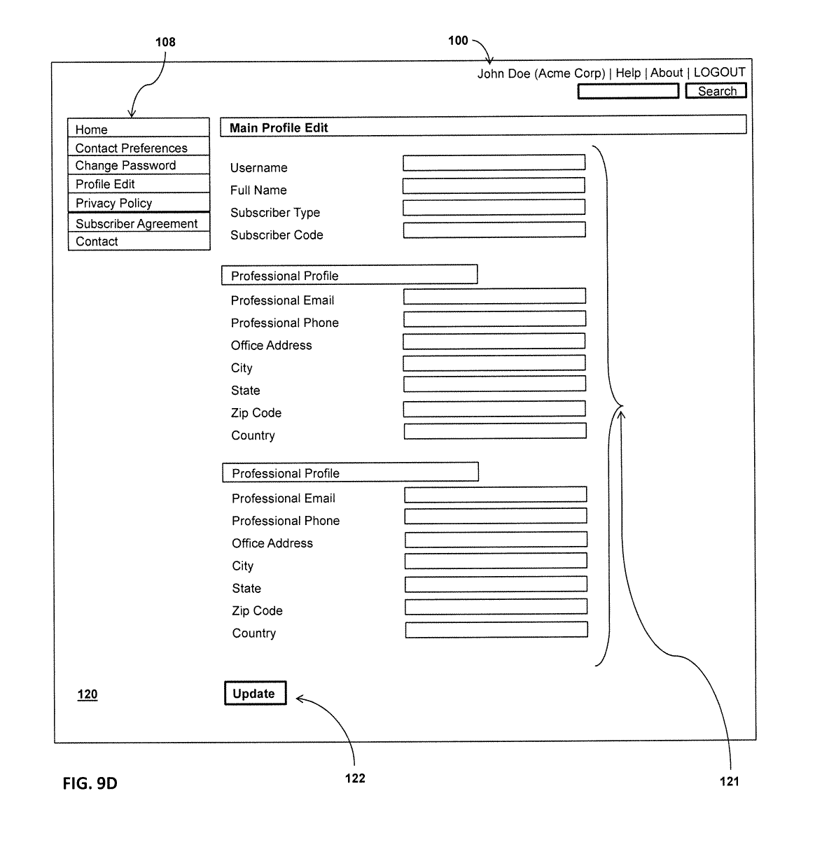

FIGS. 9A-9D show various aspects of an interface for the subscriber control center 016B according to one embodiment. FIG. 9A shows a main screen 107 where the user (subscriber) can see his or her profile information, including contact information and account details. On the left the user has a general navigation panel 108 which allows the user to navigate to different modules of the subscriber control center. The user also accumulates points for various actions such as providing information or making purchases. The points accumulated by the user are shown in screen 107 by the points block 109.

FIG. 9B shows one embodiment of an interface of the subscriber control center which allows the user to set his or her delivery control preferences. In screen 110 the user can set his or her contact preferences for his/her professional email account and phone line. The screen 110 consists of the professional preferences tab 111 and the personal preferences tab 112. In the screen the professional preferences tab is currently selected, therefore the user can set preferences for the professional email account in the email panel 113 and for the professional phone line in the phone panel 114. Once the user has updated the preferences, he can store them by clicking the update button 115.

FIG. 9C shows one embodiment of an interface screen for setting personal channel preferences 116. The personal preferences tab 112 is selected therefore the user can set personal email preferences in the email panel 117 and set the personal phone preferences in the phone panel 118. Once the preferences are updated the user can store them by clicking the update button 119.

FIG. 9D shows one embodiment of a profile edit screen 120. The user can update his or her profile by entering new information for the various fields in the textboxes in the column 121. Once the new details are entered, the user can store them by clicking the update button 122.

FIGS. 1-9 illustrate one embodiment of the invention for controlled delivery of marketing messages. This embodiment is not meant to limit the present invention and modifications thereto will be apparent to the skilled person.

### B. Combined Search and Direct Marketing

Search marketing, as it is currently implemented (e.g., Google) involves search engines displaying ads from marketers on a Web page when users search for a particular keyword. When users click on the ads, they are sent to the advertiser's Web page and the advertiser pays the search engine for the referral. This is very powerful model of marketing because it captures the ‘intentions’ of the consumers in selecting a particular ad. However, a Web page is understood to be a very weak conversion channel—as most referred traffic just bounces off without converting into purchases.

In accordance with various embodiments of the present invention, apparatus and methods are provided which combine search marketing's intention based advertising with direct marketing's much more powerful conversion channels.

In accordance with one embodiment a system and method are provided wherein:
1. A subscriber searches for an item of interest via a search engine on an aggregator's Web site;
2. The aggregator associates the search with the subscriber's preferences (profile) information and stores the associated search data in the aggregator's database;
3. The aggregator then collects a plurality of such associated search data (search requests and profiles) on a particular subject matter (category) and allows marketers to submit to the aggregator a campaign of direct marketing messages (DMMs) targeted to this group of subscribers (who requested searches relevant to this category); the aggregator then provides controlled delivery (e.g., via emails, phone calls and other communication channels) as previously described to this group of subscribers based on their “intention” (subject matter of their search requests). Therefore, unlike search engines, which just redirect users to a marketer's Web page, here the marketers can send direct marketing messages to subscribers who have run searches that indicate an interest in a specific category which becomes the subject of the DMM campaign. In both cases the emails and phone calls (and other direct messages such as mobile text messaging SMSs) will only run based on the delivery preferences of each subscriber (e.g., call only when subscriber allows you to call), and only if the subscriber allows the message at all based on the subscriber's profile preferences.

This embodiment can be expanded to include requests run on other search engines with existing organic traffic, so that when a subscriber runs a search on another search engine, the aggregator receives the search data and allows marketers to send DMMs through the aggregator's network to the subscriber (again, based on the subscriber's delivery and profile preferences).

In one example, a user (subscriber) downloads program code which runs in the background on the user's computer, and when the user searches on any search engine for an item of interest (e.g., to purchase), the background code automatically captures the search phrase and sends it to the aggregator's servers; this of course happens with the user's knowledge and consent. In a second example, the aggregator partners with other search engines (e.g., ask.com, bing.com, etc.) and when users search on those sites, the partner captures the search and links it to the aggregator's subscriber using a cookie placed on the user's machine and sends over the pair of the search phrase and cookie ID (which identifies the user) to the aggregator. Again, the identifying cookie is placed on the user's machine by the aggregator with his/her knowledge and consent. In both cases, the aggregator then follows the same process of taking the search query and linking it to the subscriber profile, and then allowing marketers to send promotions to subscribers based on those searches.

The primary benefit to marketers is the ability to send direct marketing messages, e.g., those that require recipient permission such as email, phone calls, SMSs, etc., to consumers based on their search behavior. This is highly valuable, since email and especially phone channels are dramatically more effective in converting leads into sales. In addition, this method allows marketers to send ‘private offers’ to consumers where the marketers can quote terms/prices for individual buyers that they otherwise would not put on public Web pages. This is a benefit to subscribers since they may receive better offers when searching through the aggregator's search engine, rather than general search engines.

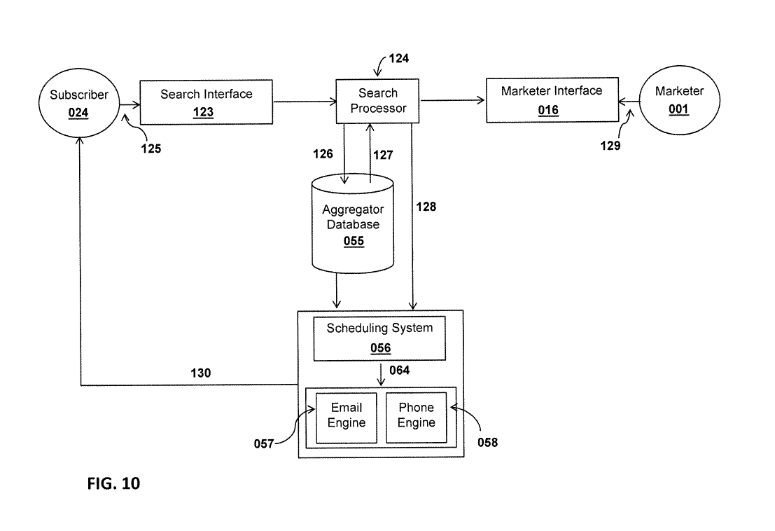

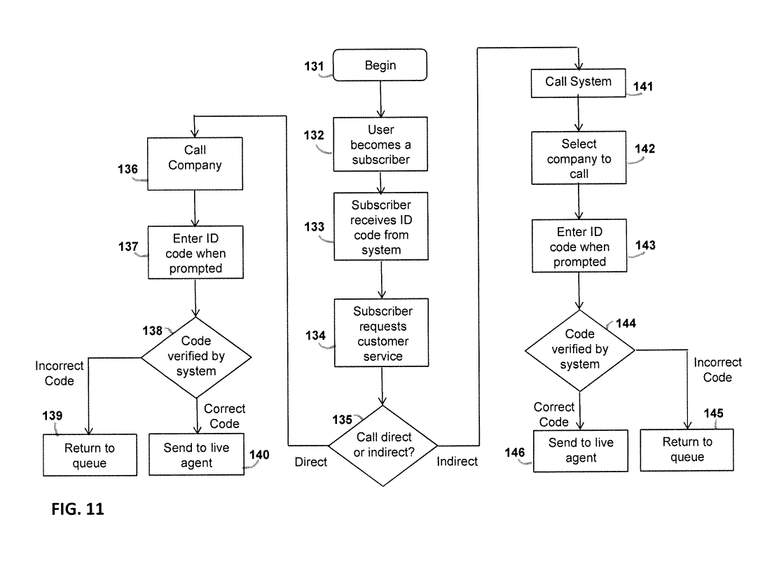

FIG. 10 illustrates one embodiment of the search and direct marketing system and method. Under this model, the subscriber 024 runs a search in the search interface 123 which in turns connects with the search processor 124. The search processor saves the search query information in the aggregator database 055 along with other relevant information through the process 126. The marketer 001 uses the marketer interface 016 provided by the platform to set up a direct marketing campaign that includes subscriber search data as a selection criteria for the subscriber target list through the process 129. The subscriber search data is made available to the marketer from the aggregator database 055 through the process 127. Once the marketer executes the campaign based on search data, the campaign details are sent to the system through the process 128 and processed by the scheduling system 056 which in turn calls the delivery engines to deliver the messages through the process 064. The email engine 057 delivers the emails messages of the campaign while the phone engine 058 delivers the phone messages to the subscriber through the process 130. Therefore the subscriber 024 receives marketing messages from the marketer 001 based on the searches that the subscriber had run earlier, which presumably reveal relevant information about the subscriber's interests, requirements and intentions.

Again, FIG. 10 illustrates one embodiment and is not intended to limit the invention; modifications thereof will be apparent to the skilled person.

### C. Customer Service

There is a persistent problem with phone based customer support. Often times when consumers call customer service, they are forced to navigate long chains of instructions and/or to wait on hold for very long times (20-40 minutes). In accordance with a further embodiment of the invention, and as an additional (optional) feature of the prior embodiments, the aggregator's network allows subscribers to pay for immediate service. The aggregator charges subscribers a monthly fee, in return for which, whenever the subscribers call a participating network company, they receive substantially immediate access to a live agent without any wait.

According to one embodiment, a system and method are provided for:
1. Creating accounts for subscribers and assigning them special codes.
2. Having network companies provide the aggregator with a special phone number which when called, will deliver a live agent for assistance within a very short period of time, ideally without any wait.
3. The subscriber can either:
(a) Call a number given to them by the aggregator, or search the aggregator's directory (on the aggregator's Web page) to find the network company they want to connect with, and select it. The aggregator then calls the special number provided by the network company and connects the subscriber to that number;
   (b) Call the network company's support number directly. The company's Interactive Voice Response (IVR) will prompt the caller to enter the special code to avail of the premium support service. When the caller enters the code, the company's IVR redirects the information to the aggregator for verification. The aggregator verifies and returns a response to the company's IVR. If the response says that code should be accepted, the company's IVR will put the caller directly in touch with a live agent.

The benefits of this system are multi-fold. For the consumers, they save considerable amounts of time when they require support by getting direct access to a live agent immediately rather than navigating through endless IVR loops and/or waiting on hold for tens of minutes. For the businesses providing support, this model allows them to better manage incoming calls and actually allows them to earn revenue from their support center (which is usually a pure cost center) as the aggregator will share the subscription fees paid by the consumers with the network companies. Consumers also get better support across the entire network of participating companies.

FIG. 11 illustrates one embodiment of a system for prioritized customer service where customers pay a subscription fee to the aggregator and in return get special privileges when they request customer services from companies that are affiliated with the aggregator. For instance, the subscribers can jump ahead in the queue and get immediate access to a live agent without having to wait, when they call an affiliate company for service.

In FIG. 11, the process starts at 131. At 132 the user becomes a subscriber by signing up for the service. When the user signs up, he receives a unique ID code at 133. Next, the subscriber requests customer service from an affiliated company at 134. The subscriber can choose to either call the company directly or call the aggregator and reconnect with the company through the aggregator. The subscriber decides which way to call at 135. If the subscriber decides to call direct, he makes the call to the company 136. An interactive voice response (IVR) system of the company prompts the subscriber to enter his unique ID at 137, in case he has one. The subscriber enters the code, which the system on the affiliated company's end verifies at 138. If the code does not validate, the subscriber is given another chance to enter the code or he is returned to the regular queue to wait at 139. If the code validates, the subscriber is connected with a live agent immediately at 140. If the subscriber decides to call the aggregator first instead of the company directly, then he makes the call to the system at 141. The user then proceeds to select the company he wants to call at 142. Next the system requests the unique ID which the subscriber enters at 143. The system on the aggregator's end then checks the code at 144. If the code does not validate, the user is given another chance to enter the code; if it is not validated he is reconnected with the target company and put in the regular queue at 145. If the code validates, the user is connected with a live agent at the target company immediately at 146.

Again, FIG. 11 illustrates one embodiment which is not intended to limit the invention; modifications will be apparent to the skilled person.

### D. System, Method and Computer Program Product

As will be appreciated by one skilled in the art, various embodiments of the present invention may be embodied as an apparatus and method, e.g., a system, method or computer program product. It may take the form of hardware, software (including firmware, resident software, micro-code, etc.) or an embodiment combining software and hardware. The invention may take the form of a computer program product embodied in a tangible medium of expression having computer-usable product code stored in the medium. The code may be written in any of various programming languages such as Java, PHP, C++, C#, Java Script/Ajax, HTML and other programming languages. As used herein, database and aggregator database are not meant to be limiting, and can reside in one or more locations and/or data repositories. The invention has been described above with respect to flow chart illustrations and/or block diagrams of methods, apparatus (systems) and computer program products according to various embodiments of the invention. It will be understood that each block of the flow chart and/or block diagram can be implemented by computer programming instructions. These instructions can be provided to a processor of a general purpose computer, special purpose computer or other programmable data processing apparatus for implementing the function/acts specified in the flow chart and/or block diagrams. The flow charts and block diagrams are not limited by the architecture, functionality, operation, and/or step order disclosed. By way of example only, the described embodiments may be implemented on various computer servers such as any x86_{—}64 processor based server, for example running a Windows Operating System. The database programming may be implemented for example, in the SQL programming language.

In the previously described embodiments a network company member makes its employees available as potential subscribers, to whom the aggregator then offers registration, leaving the actual registration (to become a subscriber) to the individual employee. The various embodiments of the invention do not preclude other individuals, not affiliated with a network company member, from also registering as a subscriber.

Modifications can be made to the previously described embodiments of the present invention without departing from the scope of the invention, the embodiments being illustrative and not restrictive.

1. A computer-readable medium storing instructions for performing a method comprising:
offering each of a plurality of subscribers preferences for controlled delivery of direct marketing messages (DMMs) from marketers to each subscriber;
receiving from each subscriber an individual set of the preferences and storing the preferences;
receiving DMMs from the marketers and storing the DMMs;
scheduling delivery of the DMMs to the one or more subscribers based on each subscriber's individual set of preferences.

2. The medium of claim 1, including offering preferences to each subscriber based on one or more of:
delivery time;
delivery channel;
delivery frequency;
one or more interests of the subscriber;
one or more hobbies of the subscriber;
one or more planned purchases of the subscriber;
blocking one or more sources or senders of marketing messages.

3. The medium of claim 1, including:
receiving personal identifier information for each subscriber and storing the information;
shielding the personal identifier information from the marketers.

4. The medium of claim 3, including:
maintaining a database of the preferences and personal identifier information.

5. The medium of claim 1, including:
providing the offering and receiving steps as a Web-based process.

6. The medium of claim 1, including:
delivering the scheduled DMMs to the one or more subscribers.

7. The medium of claim 6, wherein:
the delivering step includes one or more of email, phone and other channels of communication.

8. The medium of claim 1, wherein:
the marketers define potential subscribers and the offering is made only to such potential subscribers.

9. A computer-implemented method comprising:
offering a plurality of direct marketing messages (DMMs) from marketers to subscribers;
receiving data from each subscriber identifying preferences for controlled delivery of the DMMs;
receiving data from each marketer identifying targets for the DMMs;
matching the preferences of the subscribers and the targets of the DMMs; and
scheduling delivery of the DMMs to one or more of the subscribers based on the matched preferences.

10. The method of claim 9, wherein:
the preferences include delivery preferences and profile preferences.

11. A network-based delivery system comprising:
a database containing preferences for each of a plurality of subscribers, the preferences including profile parameters and delivery parameters;
a controller managing a schedule for controlled delivery of direct marketing messages (DMMs) to the subscribers based on the preferences of each subscriber, wherein the controller operates via a network to:
receive the preferences from the subscribers;
search the database for preferences matching the DMMs; and
deliver the DMMs to one or more of the subscribers based on the matched preferences.

12. The system of claim 11, wherein:
the system includes a Web-based interface.

13. The system of claim 11, wherein:
the database includes personal identifier information for each subscriber;
the system includes an interface for marketers to identify target subscribers for the DMMs without disclosing the personal identifier information to the marketers.

14. An apparatus comprising:
an aggregator database containing preference and personal identifier information for each of a plurality of subscribers, the preferences identifying profile parameters and delivery parameters for each subscriber;
a network-based scheduling controller accessing the database and delivering direct marketing messages (DMMs) from a plurality of marketers to one or more of the subscribers based on each subscriber's preferences without disclosing the personal identifier information to the marketers.

15. A computer-implemented method comprising:
receiving from each of a plurality of subscribers preferences for controlled delivery of direct marketing messages DMMs from marketers to the subscribers, and storing the preferences;
when an individual subscriber requests a search on an Internet search engine, associating a subject matter of the search with the individual subscriber and storing the associated search and subscriber data;
collecting a plurality of the associated search and subscriber data relating to a common subject matter;
offering the collection of subscribers to the marketers for submission of a DMM campaign to the collection of subscribers;
scheduling delivery of the DMMs to the collection of subscribers based on each subscriber's preferences.

16. The method of claim 15, wherein:
the preferences include delivery preferences and profile preferences.

17. The method of claim 15, including:
receiving personal identifier information from the subscribers;
shielding the personal identifier information from the marketers.

18. The method of claim 15, wherein:
the scheduled delivery is by one or more of email, phone and other communication channels.

19. The method of claim 15, wherein:
the marketers define potential subscribers.

20. The method of claim 17, wherein:
maintaining a database of the preferences and personal identifier information and delivering the DMMs to the subscribers without disclosure of the subscriber personal identifier information to the marketers.

21. A computer-readable medium storing instructions for performing a method comprising:
offering each of a plurality of subscribers preferences for controlled delivery of direct marketing messages (DMMs) from marketers to each subscriber;
receiving from each subscriber an individual set of the preferences and storing the preferences;
receiving DMMs from the marketers and storing the DMMs;
scheduling delivery of the DMMs to one or more of the subscribers based on each subscriber's individual set of preferences;
offering to the subscribers a customer service account with one or more of the marketers.

22. The medium of claim 21, wherein:
the account provides access to a live agent of the marketer.

23. The medium of claim 21, wherein:
the account provides the subscriber with a phone number to reach the live agent.

24. The medium of claim 21, wherein:
the account provides the subscriber with a code for obtaining access to the live agent.
